(19) United States
(12) Patent Application Publication
(10) Pub. No.: US 2009/0075022 A1
(43) Pub. Date: Mar. 19, 2009

(54) HONEYCOMB STRUCTURE

(75) Inventors: Takayuki SAKAMOTO, Aisai-city (JP); Yoshiro ONO, Nagoya-city (JP); Yasushi NOGUCHI, Nagoya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-city (JP)

(21) Appl. No.: 12/201,841

(22) Filed: Aug. 29, 2008

(30) Foreign Application Priority Data
Sep. 13, 2007 (JP) 2007-237570

(51) Int. Cl. B32B 3/12

(52) U.S. Cl. 428/118; 264/631

(57) ABSTRACT

There is disclosed a honeycomb structure having excellent thermal shock resistance. The honeycomb structure contains cordierite as a main component, and has an average pore diameter of 4 μm or more and 10 μm or less, a total pore volume of 0.18 cm³/g or more and 0.22 cm³/g or less, and Young's modulus of 4 GPa or more and 6 GPa or less.

### FIELD OF THE INVENTION

The present invention relates to a honeycomb structure having excellent thermal shock resistance.

### DESCRIPTION OF THE BELATED ART

To trap particulate substances contained in an exhaust gas from an automobile and further to adsorb or absorb NOx, CO, HC and the like in the exhaust gas with a carried catalyst, a honeycomb structure made of a cordierite ceramic material has been used. Such a honeycomb structure is heated by a high-temperature exhaust gas or the like and often receives thermal shock, and hence, for the honeycomb structure, high thermal shock resistance is required.

In recent years, with the intensification of exhaust gas regulations, a system has become the mainstream in which for early activation of a catalyst, a catalytic converter using a honeycomb structure is installed in the vicinity of an engine, or the catalytic converter is also installed behind the engine (under a floor). In this system, the catalytic converter in the vicinity of the engine requires the thermal shock resistance higher than before because an exhaust gas temperature is comparatively high and the temperature remarkably changes.

Under such a situation, a thermal expansion coefficient has heretofore mainly been decreased to achieve low thermal expansion, whereby a honeycomb structure having high thermal shock resistance is obtained (e.g., see Japanese Patent Application Publication No. 7-61892 and International Publication No. 01/77043 booklet).

Specifically, a method is known in which (1) the average particle diameter of particles constituting a cordierite-forming material is decreased to improve the reactivity of the material, (2) the flat plate degree of talc particles which are one of cordierite-forming raw materials is increased to enhance an orientation property, or (3) impurities are decreased to increase micro cracks and enlarge a dent in a thermal expansion curve, whereby the coefficient of thermal expansion (CTE) of the honeycomb structure is decreased.

However, it is quite difficult to always control the constant quality of the cordierite-forming material which becomes the cordierite ceramic material. Therefore, when the above means (2) and (3) are employed and hence the material quality deteriorates, the thermal expansion coefficient easily changes, and it is sometimes difficult to secure the high thermal shock resistance.

### SUMMARY OF THE INVENTION

The present invention has been made in view of such a situation, and an object thereof is to provide new means for obtaining a honeycomb structure having excellent thermal shock resistance. To achieve this object, the present invention provides the following honeycomb structure.

That is, according to the present invention, there is first provided a honeycomb structure which comprises a material including cordierite as a main crystal phase and which has an average pore diameter of 4 μm or more and 10 μm or less, a total pore volume of 0.18 cm³/g or more and 0.22 cm³/g or less, and Young's modulus of 4 GPa or more and 6 GPa or less.

In the honeycomb structure according to the present invention, a bending strength is preferably 2 MPa or more and 3.5 MPa or less.

In the honeycomb structure according to the present invention, a bending strength (MPa)/Young's modulus (GPa) ratio is preferably in a range of 0.55 to 0.60.

Moreover, according to the present invention, there is provided a method for manufacturing a honeycomb structure, which comprises: mixing and kneading a material for clay containing, as a main material, a cordierite-forming material containing talc having an average particle diameter (particle diameters) of 10 μm or more and 30 μm or less to obtain the clay; forming the resultant clay into a honeycomb shape to obtain a formed honeycomb body; and drying and then firing the resultant formed honeycomb body to obtain one of the above honeycomb structures.

The honeycomb structure according to the present invention has an average pore diameter of 4 μm or more and 10 μm or less, a total pore volume of 0.18 cm³/g or more and 0.22 cm³/g or less, and Young's modulus of 4 GPa or more and 6 GPa or less. As compared with a conventional structure, while the total pore volume is maintained, the average pore diameter is increased, and the Young's modulus is decreased. The Young's modulus is decreased in this manner, so that the honeycomb structure according to the present invention has excellent thermal shock resistance, and a thermal shock destruction resistance coefficient of 2 or more, preferably 3 or more is realized.

The method for manufacturing the honeycomb structure according to the present invention is a method for obtaining the honeycomb structure by use of the cordierite-forming material containing talc having an average particle diameter of 10 μm or more and 30 μm or less. Contrary to a conventional thought, the average particle diameter of the particles constituting the cordierite-forming material is increased. A method for manufacturing the honeycomb structure according to the present invention produces an excellent effect that a honeycomb structure according to the present invention having the high thermal shock resistance can be obtained.

### BRIEF DESCRIPTION OF THE DRAWINGS

FIG. 1 is a perspective view schematically showing a honeycomb structure according to the present invention.

FIG. 2 is a perspective view showing a position where a sample is cut out in the honeycomb structure according to the present invention.

### REFERENCE NUMERALS

1: honeycomb structure, 11: cell, 12: partition wall, 13: outer peripheral wall

### DETAILED DESCRIPTION OF THE INVENTION

An embodiment of the present invention will hereinafter be described appropriately with reference to the drawings. However, it should be understood that the present invention is not limited to the embodiment when interpreted. The present invention can variously be changed, modified, improved or replaced based on the knowledge of a person skilled in the art within the scope of the present invention. For example, the drawings show the preferable embodiment of the present invention, but the present invention is not limited to the configuration or information shown in the drawings. Means similar or equivalent to the means described in the present description can be applied in carrying out or verifying the present invention, but preferable means are described hereinafter.

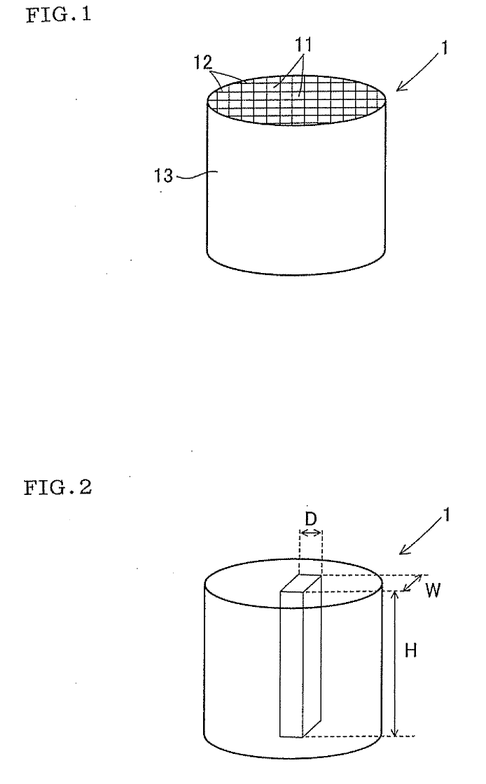

First, a honeycomb structure according to the present invention will be described. A honeycomb structure according to the present invention is specified by a material, an average pore diameter, a total pore volume and Young's modulus and is additionally specified by a bending strength in a preferable embodiment. There is not any special restriction on the shape, size or the like of the honeycomb structure. Here, FIG. 1 is a perspective view showing one embodiment of a honeycomb structure according to the present invention. The honeycomb structure 1 shown in FIG. 1 is a porous structure having the whole columnar shape in which a plurality of cells 11 are separated and formed by partition walls 12, and an outer peripheral wall 13 is arranged on the outer periphery of the structure so as to surround the partition walls 12.

A honeycomb structure according to the present invention may have a prismatic shape such as a quadrangular prism. With regard to the size of the structure, when the structure has, for example, a columnar shape, an end face diameter can be set to 30 to 500 mm, and the length of the structure in a central axis direction can be set to 25 to 350 mm. A cell density is preferably 100 to 1500 cells/inch².

In a honeycomb structure according to the present invention, a partition wall thickness is preferably 0.038 to 0.500 mm. The thickness of the outer peripheral wall which can be measured with a caliper square, a known image analysis technique, a laser measurement machine or the like is preferably uniformly 0.1 to 0.8 mm. In a honeycomb structure of the present invention, the cells in the cross section of the structure perpendicular to the central axis direction (the cross section in an outer peripheral wall direction) preferably have a polygonal shape. Specific examples of the shape preferably include a triangular shape, a quadrangular shape, a pentangular shape and a hexagonal shape.

In a honeycomb structure according to the present invention, it is preferable that one end of each predetermined cell is plugged and that the ends of the remaining cells are plugged. The structure can be formed in this manner for suitable use as a DPF. There is not any special restriction on the arrangement of the plugged cells, but it is preferable that, in the columnar honeycomb structure, the cells having one end face plugged and the cells having the other end face plugged are alternately arranged.

The average pore diameter and the total pore volume in the honeycomb structure according to the present invention are shown by values measured by a method of “the total pore volume, the median pore diameter described in 6.3 of Test Method M505-87 of a ceramic monolith carrier for an automobile exhaust gas purification catalyst according to JASO an automobile standard”.

A method for measuring the Young's modulus of a honeycomb structure according to the present invention conforms to JIS R1602 (a fine ceramic elasticity test method (a bending resonance method)). As shown in FIG. 2, a test piece is cut out along the central axis of the honeycomb structure and has a length H of 100 mm, a width W of 20 mm, and a thickness D of 10 mm.

A method for measuring the bending strength of a honeycomb structure according to the present invention conforms to JIS R1601 (a fine ceramic bending strength test method (four-point bending)). As shown in FIG. 2, a test piece is cut out along the central axis of the honeycomb structure and has a length H of 70 mm, a width W of 20 mm and a thickness D of 10 mm. A distance between lower support points was set to 60 mm, and a distance between upper load points was set to 30 mm.

Next, a method for manufacturing a honeycomb structure according to the present invention will be described. A cordierite-forming material is prepared as a material for clay. The components of this cordierite-forming material as the main material are blended so as to obtain the theoretical composition of cordierite crystals (a range as a chemical composition including 42 to 56 parts by mass of silica (SiO₂), 30 to 45 parts by mass of alumina (Al₂O₃), and 12 to 16 parts by mass of magnesia (MgO)), and hence a silica source component, a magnesia (MgO) source component, an alumina source component and the like are contained. In a method for manufacturing the honeycomb structure of the present invention, as the magnesia source component, a component containing talc having an average particle diameter of 10 μm or more and 30 μm or less is used.

As the alumina source component, one or both of aluminum oxide and aluminum hydroxide may be employed because the component contains less impurities. The magnesia source component may contain magnesite in addition to talc and impurities such as Fe₂O₃, CaO, Na₂O and K₂O. As the silica source component, quartz or molten silica is used.

Subsequently, the material for clay (an additive) to be added to the cordierite-forming material is prepared. As the additive, at least a binder is used, and a pore former is used if necessary. In addition, a dispersant and a surfactant may be used. Examples of the pore former include graphite, flour, starch, a hollow or solid resin such as phenol resin, polymethyl methacrylate, polyethylene or polyethylene terephthalate, a foaming resin and a water-absorbing polymer. Examples of the binder include hydroxypropyl methyl cellulose, methyl cellulose, hydroxyethyl cellulose, carboxyl methyl cellulose and polyvinyl alcohol. Examples of the dispersant include dextrin and polyalcohol. Examples of the surfactant include fatty acid soap.

Subsequently, the material for clay is mixed and kneaded to obtain the clay, and the clay is formed into a shape having a honeycomb structure by an extrusion forming process, a injection forming process, a press forming process or the like to obtain a formed green ceramic body. It is preferable to employ the extrusion forming process because continuous forming can easily be performed and, for example, cordierite crystals can be oriented to obtain low thermal expansion. The extrusion forming process can be performed using a device such as a vacuum kneader, a ram type extrusion former or a biaxial screw type continuous extrusion former.

Subsequently, the formed crude ceramic body is dried. The formed ceramic body can be dried by hot air drying, microwave drying, dielectric drying, reduced pressure drying, vacuum drying, freeze-drying or the like. It is preferable to perform combined drying of hot air drying and microwave drying or dielectric drying because the whole body can quickly and uniformly be dried.

Subsequently, the dried formed ceramic body is fired. During the firing, usually, the formed ceramic body using the cordierite-forming material is fired in the ambient atmosphere at a temperature of 1410 to 1440° C. for three to ten hours. A temperature rise speed of 1100° C. to the maximum temperature is preferably set to 140° C./hour or more and 280° C./hour or less. The maximum temperature preferably does not exceed 1435° C., and maximum temperature holding time is preferably three hours or more.

In the method for manufacturing a honeycomb structure of the present invention, the average particle diameter of the raw material containing talc can be measured with an X-ray transmission type particle size distribution measurement device (e.g., Sedigraph 5000-02 type manufactured by Shimadzu Corporation or the like) (in the Sedigraph process) in which Stokes liquid phase precipitation process is a measurement principle, and detection is performed by an X-ray transmission process. The average particle diameter of the particles constituting the raw material can be obtained from the distribution of particle diameters.

### EXAMPLES

Examples of the present invention will hereinafter specifically be described, but the present invention is not limited to these examples.

### Example 1

Talc (average particle diameter: 10 μm), kaolin (average particle diameter: 5 μm), alumina (average particle diameter: 5 μm) and silica (average particle diameter: 5 μm) were mixed at a ratio of 42 mass % of talc, 20 mass % of kaolin, 25 mass % of alumina, and 13 mass % of silica to prepare a cordierite-forming material. Subsequently, 100 parts by mass of this cordierite-forming material was mixed with 4 parts by mass hydroxypropyl methyl cellulose as a binder, 0.5 part by mass of lauric potash soap as a surfactant, and 30 parts by mass of water and kneaded to obtain plasticity. This plasty material was formed into a cylindrical clay with a vacuum kneader, and the clay was introduced into an extrusion former and formed into a honeycomb-like shape to obtain a formed honeycomb body.

Subsequently, the resultant formed body was dielectrically dried and then completely dried with hot air drying, and both end faces were cut to have a predetermined dimension. Then, the body was fired at 1430° C. for five hours to obtain a honeycomb structure having a size of φ144 mm×L152 mm, a partition wall thickness: 165 μm: and a cell density: 400 cells/inch². With regard to the resultant honeycomb structure, a thermal expansion coefficient in a central axis direction, water absorption, an average pore diameter, a total pore volume, a bending strength, Young's modulus, and a thermal shock destruction resistance coefficient were measured or calculated. Results are shown in Table 1. It is to be noted that methods for measuring the average pore diameter, total pore volume, bending strength, and Young's modulus have been described above. The thermal expansion coefficient in the central axis direction, the water absorption, and the thermal shock destruction resistance coefficient are as described later.

### Examples 2 to 4, Comparative Examples 1 to 3

Honeycomb structures were obtained in the same manner as in Example 1 except that the average particle diameter of talc was changed to sizes shown in Table 1. The resultant honeycomb structures were subjected to measurement or calculation in the same manner as in Example 1. Results are shown in Table 1.

TABLE 1

| | | | | | | Comparative | Comparative | Comparative |
|---|---|---|---|---|---|---|---|---|
| | Unit | Example 1 | Example 2 | Example 3 | Example 4 | Example 1 | Example 2 | Example 3 |
| Talc average | μm | 10 | 13 | 25 | 30 | 3 | 8 | 40 |
| particle diameter | | | | | | | | |
| CTE (a-axis) | ×10⁻⁶/° C. | 0.15 | 0.09 | 0.11 | 0.16 | 0.39 | 0.30 | 0.21 |
| Water absorption | Mass % | 18.6 | 21.5 | 18.8 | 17.4 | 14.7 | 16.4 | 16.3 |
| Average pore | μm | 4.2 | 5.2 | 9.1 | 9.9 | 2.4 | 3.8 | 13.3 |
| diameter | | | | | | | | |
| Total pore volume | cm³/g | 0.19 | 0.22 | 0.20 | 0.18 | 0.15 | 0.17 | 0.17 |
| Bending strength | MPa | 3.4 | 2.9 | 2.8 | 2.2 | 4.0 | 3.6 | 1.8 |
| Young's modulus | GPa | 5.3 | 4.9 | 4.9 | 4.0 | 7.8 | 6.9 | 3.5 |
| Bending strength/ | ×10⁻³ | 0.59 | 0.59 | 0.57 | 0.55 | 0.51 | 0.52 | 0.51 |
| Young's modulus | | | | | | | | |
| ratio | | | | | | | | |
| Thermal shock | — | 3.9 | 6.6 | 5.2 | 3.4 | 1.3 | 1.7 | 2.4 |
| destruction | | | | | | | | |
| resistance | | | | | | | | |
| coefficient | | | | | | | | |

It is seen from the results of Table 1 that, according to Examples 1 to 4, the honeycomb structures having a total pore volume equal to or larger than that in Comparative Examples 1 to 3, a large bending strength/Young's modulus ratio, a large thermal shock destruction resistance coefficient, and excellent thermal shock resistance can be obtained.

[Thermal Expansion Coefficient (Central Axis Direction)]

The coefficient was measured in conformity to a method described in a test method (JASO M 505-87) of a ceramic monolith carrier for an automobile exhaust gas purification catalyst according to the automobile standard established by the standard meeting of Society of Automotive Engineers of Japan.

[Water Absorption]

First, a dry mass (M1) of the honeycomb structure is measured. Then, cells of a sample are vertically aligned, and the sample is put into water. The sample is immersed in the water for one minute, taken out of the water, lightly vibrated, and drained. Afterward, the cells of the sample are vertically aligned again, and the sample is put into water. The sample is immersed in the water for one minute, and taken out of the water. The cells of the sample are vertically aligned, and the sample is mounted on a conveyor, and passed under an air nozzle which reciprocates at right angles with respect to a conveyor travel direction. After surplus water is blown and flied with air, a water absorption mass (M2) of the sample is measured. The above-mentioned operation was performed to obtain water absorption WAB from WAB=(M2−M1)M1×100 (mass %).

[Thermal Shock Destruction Resistance Coefficient]

The coefficient was obtained from bending strength/(Young's modulus×thermal expansion coefficient).

[Average Particle Diameter]

As a raw material such as talc, commercially available powders were crushed, sieved, adjusted into a predetermined average particle diameter, and used. The average particle diameter of material particles was measured with Sedigraph 5000-02 type manufactured by Shimadzu Corporation.

A honeycomb structure according to the present invention can be utilized as a filter in an application of trapping particulate substances from an automobile exhaust gas. Moreover, the structure can be utilized as a catalytic converter which carries a catalyst for purifying NOx, CO, HC and the like in an exhaust gas. In particular, the structure can suitably be utilized in an environment where excellent thermal shock resistance is required.

What is claimed:

1. A honeycomb structure which comprises a material including cordierite as a main crystal phase and which has an average pore diameter of 4 μm or more and 10 μm or less, a total pore volume of 0.18 cm³/g or more and 0.22 cm³/g or less, and Young's modulus of 4 GPa or more and 6 GPa or less.

2. The honeycomb structure according to claim 1, wherein a bending strength is 2 MPa or more and 3.5 MPa or less.

3. The honeycomb structure according to claim 1, wherein a bending strength (MPa)/Young's modulus (GPa) ratio is in a range of 0.55 to 0.60.

4. A method for manufacturing a honeycomb structure, which comprises: mixing and kneading a material for clay containing, as a main material, a cordierite-forming material containing talc having an average particle diameter of 10 μm or more and 30 μm or less to obtain the clay; forming the resultant clay into a honeycomb shape to obtain a formed honeycomb body; and drying and then firing the resultant formed honeycomb body to obtain the honeycomb structure which comprises a material including cordierite as a main crystal phase and which has an average pore diameter of 4 μm or more and 10 μm or less, a total pore volume of 0.18 cm³/g or more and 0.22 cm³/g or less, and Young's modulus of 4 GPa or more and 6 GPa or less.

5. A method for manufacturing a honeycomb structure according to claim 4, wherein a bending strength is 2 MPa or more and 3.5 MPa or less.

6. The honeycomb structure according to claim 2, wherein a bending strength (MPa)/Young's modulus (GPa) ratio is in a range of 0.55 to 0.60.
